(19) United States
(12) Patent Application Publication
(10) Pub. No.: US 2026/0260120 A1
(43) Pub. Date: Sep. 3, 2026

(54) GENERATING OUTPUT SEQUENCES WITH INLINE EVIDENCE USING LANGUAGE MODEL NEURAL NETWORKS

(71) Applicant: DeepMind Technologies Limited, London (GB)

(72) Inventors: Jacob Lee Menick, London (GB); Vladmir Mikulik, London (GB); Maja Maria Trebacz, London (GB); Nathaniel John McAleese-Park, London (GB); Geoffrey Irving, London (GB)

(21) Appl. No.: 18/846,910

(22) PCT Filed: Mar. 16, 2023
(86) PCT No.: PCT/EP2023/056778

§ 371 Date: Sep. 13, 2024

Related U.S. Application Data
(60) Provisional application No. 63/320,633, filed on Mar. 16, 2022.

(51) Int. Cl. G06N 3/092; G06F 16/3329; G06F 40/284; G06N 3/09

(52) U.S. Cl. CPC G06N 3/092; G06F 16/33295; G06F 40/284; G06N 3/09

(57) ABSTRACT

Methods, systems, and apparatus, including computer programs encoded on computer storage media, for generating output sequences using language model neural networks. In particular, the output sequences include a response to an input query and inline evidence that includes a quote from a context document that supports the response.

### CROSS-REFERENCE TO RELATED APPLICATIONS

This application claims the benefit of priority to U.S. Application Ser. No. 63/320,633, filed Mar. 16, 2022, the entirety of which is incorporated herein by reference.

### BACKGROUND

This specification relates to processing inputs using neural networks to generate output sequences.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more computers in one or more locations that generates responses to received requests using a language model neural network. In particular, the responses generated by the system include (i) a response to the request and (ii) “evidence” from one or more context text documents that supports the response. The evidence includes a direct quote from one of the context text documents.

For example, the system may provide an interface between a user and an information retrieval system which accesses a corpus of documents. The interface allows the system to leverage the information retrieval system to provide more reliable information, and in particular information which is verifiably correct.

In one aspect, a method includes receiving an input text query; obtaining one or more first context text sequences and a respective natural language identifier for each of the first context text sequences; generating a first input sequence that includes the input text query, the one or more first context text sequences, and the respective natural language identifiers for each of the one or more first context text sequences; processing the first input text sequence using an auto-regressive language model neural network to generate a first output text sequence that comprises: (i) a first output text sub-sequence that is a response to the input text query; (ii) a second output text sub-sequence that is one of the respective natural language identifiers for the first context text sequences, and (iii) a third output text sub-sequence that is text from the first context text sequence identified by the natural language identifier in the second output text sub-sequence; and providing at least the first output text sub-sequence and the third output text sub-sequence in response to the input text query.

In some implementations, providing at least the first output text sub-sequence and the first context text sequence in response to the input text query comprises providing the first output text sub-sequence, the second output text sub-sequence, and the third output text sub-sequence in response to the query.

In some implementations, the method further includes determining, from the second output text sub-sequence, a source of the first context text sequence identified by the natural language identifier in the second output text sub-sequence; and providing a reference to the source of the first context text sequence in response to the query.

In some implementations, the method further includes obtaining one or more second context text sequences and a respective natural language identifier for each of the second context text sequences; generating a second input sequence that includes the input text query, the one or more second context text sequences, and the respective natural language identifiers for each of the one or more second context text sequences; processing the second input text sequence using the auto-regressive language model neural network to generate a second output text sequence that comprises: (i) a fourth output text sub-sequence that is a response to the input text query; (ii) a fifth output text sub-sequence that is one of the respective natural language identifiers for the second context text sequences, and (iii) a sixth output text sub-sequence that is text from the second context text sequence identified by the natural language identifier in the fifth output text sub-sequence; generating a respective score for each output text sequence in a set that includes the first and second output text sequences; determining that the first output text sequence has a highest score of any output text sequence in the set; and providing at least the first output text sub-sequence and the third output text sub-sequence in response to the input text query in response to determining that the first output text sequence has the highest score.

In some implementations, generating a respective score for each output text sequence in a set that includes the first and second output text sequences comprises: scoring each of the output text sequences using a learned reward model.

In some implementations, the first output sequence includes a respective token from a vocabulary of tokens at each of a plurality of time steps, wherein the auto-regressive neural network is configured to, for each time step in the first output sequence (e.g. for each time of the plurality of time steps; the token corresponding to a current time step may conveniently be called a “current token”), generate a respective score for each token in the vocabulary conditioned on the first input text sequence and any tokens in the output sequence at any time steps before the time step in the first output sequence (any tokens in the output sequence preceding the current token), and wherein generating the first output sequence comprises: at each time step, selecting the token at the time step (the current token) using the respective scores for the tokens in the vocabulary generated by the neural network for the time step.

In some implementations, tokens of the second output text sub-sequence also correspond to corresponding ones of a (second) plurality of time steps. Generating the first output sequence comprises: at each time step in the second output text sub-sequence (each of the second plurality of time steps) that is after the first time step in the second output text sub-sequence: receiving the respective scores generated by the neural network at the time step; generating a constrained score distribution that assigns a non-zero score only to tokens that immediately follow the tokens already generated within the second output text sub-sequence in one of the natural language identifiers; and sampling the token at the time step from the constrained score distribution.

In some implementations, the second output text sub-sequence is preceded by one or more first predetermined syntax tokens in the first output text sequence, and generating the first output sequence comprises: at a particular time step, determining that the one or more first predetermined syntax tokens have been selected at one or more time steps immediately preceding the particular time step and, in response, determining that the particular time step is the first time step in the second output text-subsequence; receiving the respective scores generated by the neural network at the particular time step; in response to determining that the particular time step is the first time step in the second output text-subsequence, generating a constrained score distribution that assigns a non-zero score only to tokens that are the first token in one of the natural language identifiers; and sampling the token at the time step from the constrained score distribution.

In some implementations, tokens of the third output text sub-sequence also correspond to corresponding ones of a (third) plurality of time steps. Generating the first output sequence comprises: at each time step in the third output text sub-sequence (i.e. each of the third plurality of time steps) that is after the first time step in the third output text sub-sequence: receiving the respective scores generated by the neural network at the time step; generating a constrained score distribution that assigns a non-zero score only to tokens that immediately follow the tokens already generated within the third output text sub-sequence in the first context text sequence identified by the natural language identifier in the second output text sub-sequence; and sampling the token at the time step from the constrained score distribution.

In some implementations, the third output text sub-sequence is preceded by one or more second predetermined syntax tokens in the first output text sequence, and generating the first output sequence comprises: at a second particular time step, determining that the one or more second predetermined syntax tokens have been selected at one or more time steps immediately preceding the second particular time step and, in response, determining that the particular time step is the first time step in the third output text-subsequence; receiving the respective scores generated by the neural network at the particular time step; in response to determining that the particular time step is the first time step in the third output text-subsequence, generating a constrained score distribution that assigns a non-zero score only to tokens that appear in the first context text sequence identified by the natural language identifier in the second output text sub-sequence; and sampling the token at the time step from the constrained score distribution.

In some implementations, obtaining one or more first context text sequences and a respective natural language identifier for each of the first context text sequences comprises: submitting a query derived from the input text query to a search engine; obtaining, from the search engine, one or more context documents in response to the query; and selecting the one or more first context sequences from the one or more context documents.

In some implementations, the respective natural language identifier for each of the first context text sequences is a title of the context document from which the first context text sequence is selected.

In some implementations, the neural network has been pre-trained through unsupervised learning on a language modeling objective.

In some implementations, the neural network has been fine-tuned through supervised learning, reinforcement learning, or both.

The subject matter described in this specification can be implemented in particular embodiments so as to realize one or more of the following advantages.

The system described in this specification provides a user interface for accessing a generative language model neural network that generates responses to received requests. In particular, generative language models (LMs) are increasingly useful for answering questions about the world. By default, however, LMs generate ungrounded claims that users must choose to either blindly accept or to verify themselves.

This specification describes techniques that help the user evaluate responses generated by the LM by generating claims alongside supporting evidence. In particular, this evidence takes the form of a verbatim quote extracted from a longer context document retrieved from one or more textual databases. The documents may be retrieved by an Internet search engine or any other suitable information retrieval system. Thus, the present system provides a user interface between the user and the information retrieval system, and which enhances the reliability and verifiability of information obtained using the information retrieval system.

In order to ensure the quotes are “verbatim” with a generative approach, this specification describes a special syntax for the language model to use when quoting from documents and in some cases, based on this syntax, constraining the outputs of the language model to be exact quotes from the retrieved documents. This can ensure that the language model accurately quotes from the context document even though the model was pre-trained on an objective that did not require quoting from inputs.

Moreover, large-scale language models implemented as neural networks can produce impressive results on a range of natural language processing tasks, including question answering. However implementations of some these models, particularly Transformer-based models, can have more than a billion parameters and can require substantial computing resources, power, and time to process a network input to generate the network output. Sometimes such models can have can more than 10 billion or more than 100 billion parameters. If such models were used at scale to serve a large number of user requests, significant energy would be consumed.

An additional consideration arises when the neural network is implemented on a digital assistant device, e.g., a mobile device, implemented in a computing system that includes a back end component, in particular a data server, in communication with the digital assistant device over a data communications network such as the Internet. There is then a need to optimize the computing load between the digital assistant device and the back end component. This need can be particularly acute with a large-scale language model because of its substantial memory and computing requirements compared with those typically found on a mobile device.

The techniques described herein address these problems. In some implementations the described techniques facilitate a reduced a computational load, and improved load distribution, particularly when the large-scale language model is implemented as a neural network in a multitasking and parallel processing computer system, distributed across multiple sites and interconnected by a data communication network.

In some implementations the described techniques enable a beneficial distribution of computing load between a local, mobile computing device and a back-end server in a network. More particularly, in implementations, by conditioning the language model neural network on context representing documents obtained from an Internet search based on a question, the use of a smaller language model neural network is enabled, which facilitates implementing the neural network on a mobile device with limited memory and computing resources.

Further, using techniques described in this specification, a system can leverage search engine results to generate a prediction about an input text using up-to-date information included in the search engine results. Some existing systems use pre-trained neural networks without access to such search engine results to generate predictions, and so the predictions can be less reliable because the neural network can only encode information that was available to the neural network during training; that is, these predictions can rely on stale information and thus be incorrect or at least out of date. Thus, using techniques described in this specification, a system can generate predictions that are more accurate and timely.

Furthermore, some existing systems must repeatedly re-train neural networks to ensure that the neural networks encode the latest information. Because the systems described in this specification can repeatedly access new search engine results, the system is not required to re-train the neural network, thus saving significant computational resources.

Using techniques described in this specification, a system can generate predictions for an input text using the information encoded in multiple different documents provided by a search engine in response to processing a search engine query. The multiple different documents can each include respective different information that is relevant to the prediction. Thus, the predictions generated by the system can be more accurate than predictions generated using a single document.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 is a diagram of an example sequence generation system.

FIG. 2 is a flow diagram of an example process for generating an output sequence.

FIG. 3 is a flow diagram of an example process for selecting a candidate output sequence.

FIG. 4 shows an example user interface that presents an output sequence to a user.

FIG. 5 shows an example of training the language model neural network.

FIG. 6 shows an example user interface for rating a generated sample.

Like reference numbers and designations in the various drawings indicate like elements.

### DETAILED DESCRIPTION

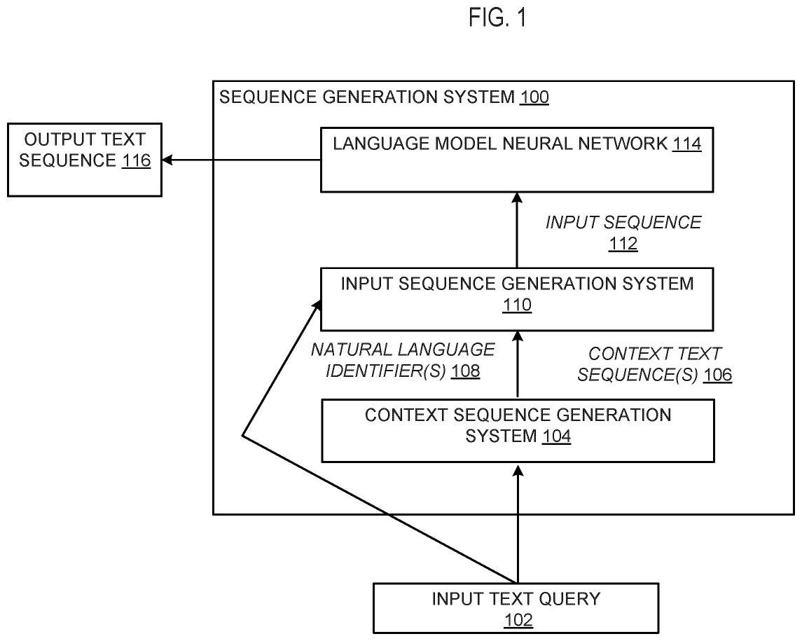

FIG. 1 shows an example sequence generation system 100. The sequence generation system 100 is an example of a system implemented as computer programs on one or more computers in one or more locations, in which the systems, components, and techniques described below can be implemented.

The sequence generation system 100 acts as a user interface to an information retrieval system which accesses one or more textual databases (not shown), or provides functionality for a user interface implemented on a user computer which is separate from the sequence generation system 100 but in communication with it. The textual databases collectively form a corpus of documents. The corpus of documents may for example be the webpages and other documents accessible through the internet. Alternatively, the corpus of documents may, for example, be part of a proprietary textual database, e.g. of a scientific publisher or other organization. The sequence generation system 100 processes an input text query 102 from a user using a context sequence generation system 104, an input sequence generation system 110, and a language model neural network 114 to generate an output sequence 116.

The input text query 102 can be a query submitted to the system 100 by a user through a user computer, a question submitted to the system 100 by through the user computer, or a different request that requires a response from the system 100. In some cases, the system receives the query as text from the user computer. In some other cases, the system receives a natural language speech query from the user and converts the speech into the input text query 102 by applying a speech recognition engine to the speech. The input text query 102 may be received in the form of a sound (speech) signal, captured by a microphone of the user computer, which is converted by a speech recognition engine, i.e., a speech-to-text converter to form the input text query 102. Alternatively, it may be entered by typing using a data input device of the user computer.

Once the system 100 receives the input text query 102, the context sequence generation system 104 obtains one or more first context text sequences 106 and a respective natural language identifier 108 for each of the first context text sequences 106.

For example, each context text sequence 106 can be extracted from a respective context document and the identifier 108 can be the title of the context document. As another example, some or all of the context text sequences 106 can be extracted from the same context document and the identifier 108 can be a section header or other identifier for the portion of the document from which the context text sequence is extracted.

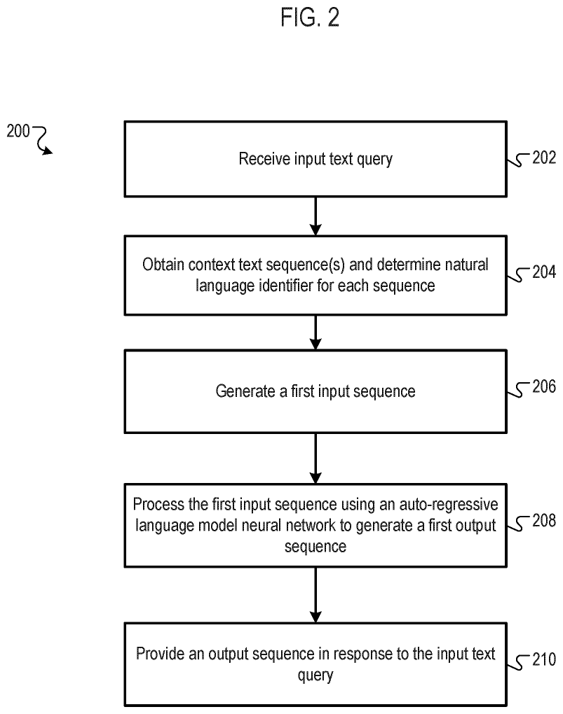

Obtaining context sequences is described in more detail below with reference to FIG. 2.

The input sequence generation system 110 then generates a first input sequence 112 that includes the input text query 102, the one or more first context text sequences 106, and the respective natural language identifiers 108 for each of the one or more first context text sequences.

For example, the first input sequence 112 can include the query 102, the context text sequences 106, and the identifiers 108 arranged according to a pre-determined input syntax.

In some cases, the first input sequence 112 can include also include other text, e.g., one or more natural language “prompts,” one or more separator tokens separating the various elements of the input sequence, or both. A natural language prompt is an example of an input—output pair, where the input is an example of an input that can be provided and the output is an example of an output that should be generated. Prompts will be described in more detail below.

The sequence generation system 100 then processes the first input sequence 112 using an auto-regressive language model neural network 114 to generate a first output text sequence 116.

The output sequence 116 includes (i) a first output text sub-sequence that is a response to the input text query 102, (ii) a second output text sub-sequence that is one of the respective natural language identifiers 108 for the first context text sequences 106, and (iii) a third output text subsequence that is text from the first context text sequence identified by the natural language identifier in the second output text sub-sequence.

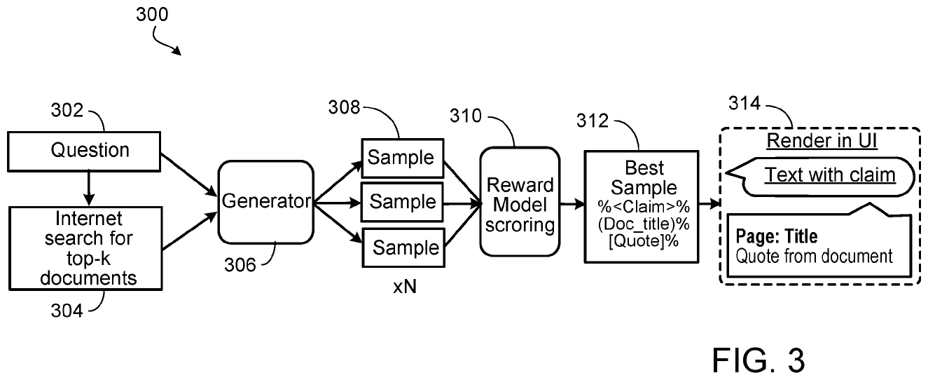

In particular, (i), (ii), and (iii) are arranged within the output sequence according to a pre-determined output syntax. One example of a pre-determined syntax is described in more detail below with reference to FIG. 3.

The sequence generation system 100 then provides at least the first output text sub-sequence and the third output text sub-sequence in response to the input text query 102. Thus, the system 100 provides a text response to the input text query 102 and text from one of the context text sequences 106 as supporting evidence for the text response.

In some implementations, the sequence generation system 100 generates multiple candidate output sequences 116 in response to the input query 102.

In these implementations, the system 100 also generates a respective score for each candidate output sequence, and only provides text from the highest-scoring candidate output sequence in response to the user query.

In some of these implementations, if none of the candidates have a score that exceeds a threshold, the system 100 instead emits a default text response to the user query, e.g., “I don't know” or “I am not sure.”

Scoring candidate output sequences is described below with reference to FIG. 3.

The language model neural network 114 can be any appropriate language model neural network that receives an input sequence made up of text tokens selected from a vocabulary and auto-regressively generates an output sequence made up of text tokens from the vocabulary. For example, the language model neural network 114 can be a Transformer-based language model neural network or a recurrent neural network-based language model.

The tokens in the vocabulary can be any appropriate text tokens, e.g., words, word pieces, punctuation marks, and so on, that represent elements of text in one or more natural languages and, optionally, numbers and other text symbols that are found in a corpus of text. Generally, the input text query 102, the natural language identifier(s) 108 and/or the context text sequence(s) 106 are also sequences of tokens selected from the vocabulary.

The language model neural network 114 is referred to as an auto-regressive neural network because the neural network 114 auto-regressively generates an output sequence of tokens by generating each particular token in the output sequence conditioned on a current input sequence that includes any tokens that precede the particular text token in the output sequence, i.e., the tokens that have for already been generated for any previous positions in the output sequence that precede the particular position of the particular token, and a context input that provides context for the output sequence.

For example, the current input sequence when generating a token at any given position in the output sequence can include the input sequence and the tokens of the output sequence at any preceding positions that precede the given position in the output sequence. As a particular example, the current input sequence can include the input sequence followed by the tokens at any preceding positions that precede the given position in the output sequence. Optionally, within the current input sequence, the input sequence and the tokens from the output sequence can be separated by one or more predetermined tokens, i.e., a designated set of one or more tokens from the vocabulary, within the current input sequence. That is, there can be one or more predetermined tokens between the input sequence and the tokens from the output sequence.

More specifically, to generate a particular token at a particular position within an output sequence, the neural network 114 can process the current input sequence to generate a score distribution, e.g., a probability distribution, that assigns a respective score, e.g., a respective probability, to each token in the vocabulary of tokens. The neural network 114 can then select, as the particular token, a token from the vocabulary using the score distribution. For example, the neural network 114 can greedily select the highest-scoring token or can sample, e.g., using nucleus sampling or another sampling technique, a token from the distribution.

As a particular example, the language model neural network 114 can be an auto-regressive Transformer-based neural network that includes (i) a plurality of attention blocks that each apply a self-attention operation and (ii) an output subnetwork that processes an output of the last attention block to generate the score distribution.

The neural network 114 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the neural network 114 is auto-regressive, the system 100 can use the same neural network 114 to generate multiple different candidate output sequences in response to the same request, e.g., by using beam search decoding from score distributions generated by the neural network 114, using a Sample-and-Rank decoding strategy, by using different random seeds for the pseudo-random number generator that is used in sampling for different runs through the neural network 114 or using another decoding strategy that leverages the auto-regressive nature of the neural network 114.

In some implementations, the language model 114 is pre-trained, i.e., trained on a language modeling task that does not require providing evidence in response to user questions, and the system 100 causes the neural network 114 to generate output sequences according to the pre-determined syntax through natural language prompts in the input sequence.

For example, the system 100 or another training system pre-trains the language model neural network 114 on a language modeling task, e.g., a task that requires predicting, given a current sequence of text tokens, the next token that follows the current sequence in the training data. As a particular example, the language model neural network 114 can be pre-trained on a maximum-likelihood objective on a large dataset of text, e.g., text that is publically available from the Internet or another text corpus.

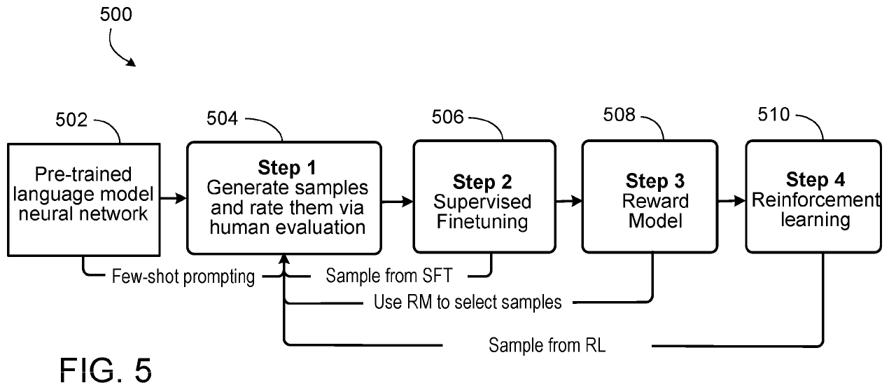

In some other implementations, after the pre-training, the system 100 fine-tunes the language model 114, e.g., through supervised learning, reinforcement learning, or both, on objectives that do require output sequences to be generated according to the syntax. This is described in more detail below with reference to FIG. 5.

In some of these implementations, the system 100 still includes one or more natural language prompts in the inputs to the language model 114 at inference, i.e., after training.

As described above, a natural language prompt is an example of an input-output pair, where the input is an example of an input that can be provided and the output is an example of an output that should be generated. Thus, each prompt will include an example input sequence that an example query, an example set of one or more context sequence, and respective identifiers for the one or more context sequences arranged according to the pre-determined input syntax. Each prompt will also include, arranging according to the output syntax, an example first output text sub-sequence that is a response to the example query, an example second output text sub-sequence that is one of the respective natural language identifiers for one of the example context text sequence, and an example third output text subsequence that is text from the example context text sequence identified by the natural language identifier in the example second output text sub-sequence. Optionally, the input sequence can also include one or more tokens from the vocabulary separating each prompt and one or more tokens separating the final prompt from the user query.

Additionally, in some implementations, the system 100 performs “constrained sampling” when selecting tokens to be included in the output sequence. This can ensure that the outputs of the neural network 114 follow the syntax and that the sequences are internally consistent, i.e., ensures that the evidence is a direct quote from the context text sequence 106 identified by the natural language identifier 108 in the output sequence.

In cases where the system 100 generates multiple candidate output sequences, constrained sampling prevents the system from having to score invalid or inconsistent output sequences and drastically reduces the number of candidates that need to be generated to ensure a high-quality output, greatly improving the computational efficiency of the system 100, i.e., reducing the amount of computational resources consumed by the system 100.

An example of constrained sampling is described in more detail below with reference to FIG. 3.

FIG. 2 is a flow diagram of an example process 200 for generating an output sequence given an input query. For convenience, the process 200 will be described as being performed by a system of one or more computers located in one or more locations. For example, a sequence generation system, e.g., the sequence generation system 100 depicted in FIG. 1, appropriately programmed in accordance with this specification, can perform the process 200.

The system receives an input text query (step 202), e.g., from a user using a user interface.

The system obtains one or more first context text sequences and a respective natural language identifier for each of the first context text sequences (step 204).

For example, the system can obtain the one or more context sequences and a respective natural language identifier for each of the first context sequences by submitting a search query derived from the input text query to a search engine. The search engine has access to the corpus of documents, and is configured to search the corpus of documents based on the search query. For example, the search query can be the same text as the input text query or can be modified by the system, e.g., to add synonyms, correct typographical or spelling mistakes, and so on.

Then, the system can obtain, from the search engine, one or more documents in response to the search query. The one or more documents can be ranked by the search engine, e.g., according to quality and relevance to the received search query.

The system can then select one or more first context sequences from the one or more context documents, e.g., by selecting the one or more highest-ranked search results. The system also associates a respective natural language identifier with each first context sequence.

In some implementations, the search engine also provides a snippet from the corresponding context document as part of the search result identifying the corresponding context document. In some of these implementations, the system can generate a context sequence for a given document by extracting the snippet and text surrounding the snippet from the corresponding context document. For example, the system can extract snippet text using snippets in order to account for document lengths being varied and often exceeding the language model max context window size (as described below).

Thus, especially in the case of few-shot prompting when presenting multiple documents at once, the system may need to restrict the number of tokens spent on the document content within a given input sequence. Hence, the system can truncate the documents by using the snippets as described above. For example, the system can use the snippets to truncate a given document to a maximum token length fragment such that the fragment contains the relevant search snippet.

In some implementations, the system can ensure that the truncated fragment starts from the beginning of a sentence or paragraph.

As a particular example, at train time, the system can choose such the start position at random to increase the variety of the inputs. At inference time, the system can allow a maximum number, e.g., 250, 500, or 1000 characters before the start of the snippet fragment, and identify the first sentence that starts in that range and uses that first sentence as the beginning of the truncated fragment.

The search engine can be any appropriate search engine that is accessible by the system and that searches any appropriate corpus of documents, e.g., web pages, books, or other documents. For example, the search engine can be an Internet search engine that searches through and returns results that reference documents available on the Internet. As another example, the search engine can be a different search engine that searches a private corpus of documents, e.g., documents available on an internal network or stored in a collection of one or more databases.

For example, the respective natural language identifier for each of the first context text sequences can be a title of the context document from which the first context text sequence is selected.

The system generates a first input sequence that includes the input text query, the one or more first context text sequences, and the respective natural language identifiers for each of the one or more first context text sequences (step 206).

The system processes the first input text sequence using an auto-regressive language model neural network to generate a first output text sequence (step 208).

The first output text sequence includes a first output text sub-sequence that is a response to the input text query, a second output text sub-sequence that is one of the respective natural language identifiers for the first context text sequences, and a third output text sub-sequence that is text from the first context text sequence identified by the natural language identifier in the second output text sub-sequence.

The system provides at least the first output text sub-sequence and the third output text subsequence (e.g. to the user) in response to the input text query (step 210).

The system can provide the first output text sub-sequence, the third output text sub-sequence, and, optionally, the second output text sub-sequence in response to the query.

Additionally, in some implementations, the system can determine, from the second output text sub-sequence, a source of the first context text sequence identified by the natural language identifier in the second output text sub-sequence and provide a reference to the source of the first context text sequence in response to the query. For example, the system can provide the reference as a hyperlink that links to the source, e.g., the web page, of the first context text sequence.

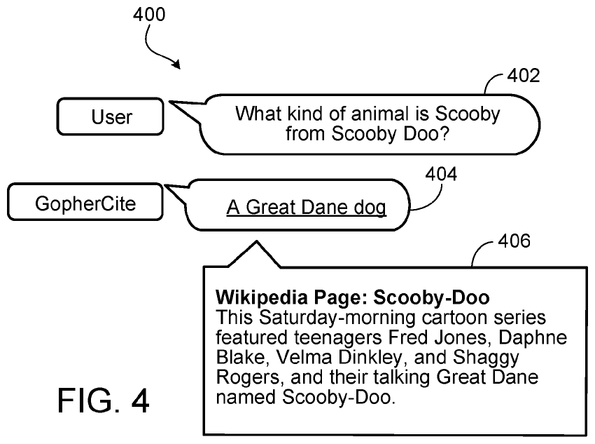

An example presentation of an output sequence generated by the system is described below with reference to FIG. 4.

As described above, in some implementations, the system generates a set of multiple candidate output sequences (that include the first output text sequence), and for each candidate output sequence a respective score, and only provides the first output sequence in response to determining that the first output text sequence has the highest score of any of the candidate output sequences.

For example, the system can generate at least some of the candidate output sequences in the set by sampling different candidate output sequences from outputs generated by the language model neural network when processing the first input text sequence.

Additionally, in some implementations, the system can generate more context sequences than can fit in the “context window” of the language model neural network. That is, the language model neural network may, e.g., due to memory constraints or due to the framework in which the neural network was trained, only be able to process input sequences that do not have more than a maximum number of characters. In some implementations, including the natural language identifiers and the tokens for all of the context sequences can exceed this maximum number. In these implementations, the system generates multiple different input sequences that each include a respective subset of the context sequences.

In other words, in addition to the first context text sequence, the system can also obtain one or more second context text sequences and a respective natural language identifier for each of the second context text sequences and generate a second input sequence that includes the input text query, the one or more second context text sequences, and the respective natural language identifiers for each of the one or more second context text sequences. The system can then process the second input text sequence using the auto-regressive language model neural network to generate a second output text sequence that comprises: (i) a fourth output text sub-sequence that is a response to the input text query; (ii) a fifth output text sub-sequence that is one of the respective natural language identifiers for the second context text sequences, and (iii) a sixth output text sub-sequence that is text from the second context text sequence identified by the natural language identifier in the fifth output text sub-sequence.

Then, the system generates a respective score for each candidate output text sequence in the set, e.g., the set that includes the first and second output text sequences, and determines that the first output text sequence has the highest score of any output text sequence in the set. In some cases, this can be done by scoring each of the output text sequences using a learned reward model. Using a learned reward model to score candidate output sequences is described below with reference to FIG. 3.

The system can then provide at least the first output text sub-sequence and the third output text subsequence in response to the input text query in response to determining that the first output text sequence has the highest score.

FIG. 3 shows an example of the operation of the sequence generation system when the system generates multiple candidate output sequence in response to a given text query.

As shown in the example of FIG. 3, the system 100 receives a question 302, e.g., from a user computer.

The system 100 performs an Internet search 304 to identify the top k most relevant documents to the question 302. Generally, k is an integer greater than one, e.g., 5, 10, 20, or 100. For example, the system 100 can provide the question 302 or a query derived from the question 302 to an Internet search engine and, obtain, from the Internet search engine, search results identifying the top k documents.

The system then uses a generator 306 to generate one or more input sequences to the language model neural network 114 and samples 308 N candidate output sequences using the language model neural network 114. In some implementations, the number of candidate output sequences, N, is be greater than the number of documents, k.

For example, the generator 306 can generate a single input sequence that includes context from all of the k documents and then process the single input sequence multiple times using the language model neural network 114 to sample the N candidate output sequences.

As another example, the generator 306 can generate multiple input sequences that each include context from a respective subset of the k documents and then process each of the multiple input sequences multiple times using the language model neural network 114 to sample the N candidate output sequences.

As another example, the generator 306 can generate multiple input sequences that each include context from a respective one of the k documents and then process each of the multiple input sequences using the language model neural network 114.

In either of the above examples, the multiple input sequences may be sampled in a round robin order until the N candidate output sequences have been sampled.

In some implementations, N may be a multiple of k. In other implementations, N may be indivisible by k.

The system 100 then performs reward model scoring 310 of each of the N candidate output sequences.

That is, the system 100 assigns a respective score to each of the N candidate output sequences using a learned reward model.

The learned reward model 310 is a model, e.g., another language model neural network, that receives as input an input text query and a response and a quote generated by the neural network 114 and generates as output a score that represents the quality of the response and quote. For example, the score can represent a likelihood that a user would prefer the response (and quote) relative to other responses (and accompanying quotes) to the same query generated by the neural network 114.

Training the reward model is described below with reference to FIG. 5.

The system 100 then selects, as the final output sequence, the “best” sample 312, i.e., the candidate output sequence from N sequences that has the highest score according to the learned reward model.

In some implementations, if none of the candidates have a score that exceeds a threshold, the system 100 instead emits a default text response to the user query, e.g., “I don't know” or “I am not sure.”

As described above, each candidate output sequence includes (i) a first output text sub-sequence that is a response to the input text query, (ii) a second output text sub-sequence that is one of the respective natural language identifiers for the first context text sequences, and (iii) a third output text sub-sequence that is text from the first context text sequence identified by the natural language identifier in the second output text sub-sequence.

In particular, (i), (ii), and (iii) are arranged within the output sequence according to a pre-determined output syntax.

As shown in the example of FIG. 3, the output syntax is:
%<Claim>% (Document title) %[Quote from document]%
   where “%<” “>% (“ ”) % [” and “]%” are template tokens, i.e., predetermined syntax tokens that are inserted before and after sub-sequences, “claim” is a placeholder for the first output text sub-sequence, “Document title” is a placeholder for the second output text sub-sequence, and “Quote from document” is a placeholder for the third output text sub-sequence.

However, any of a variety of syntaxes that place the “claim” placeholder, the “document title” placeholder, and the “quote from document” placeholder in predetermined places within the output sequences can be used.

In some implementations and as described above, the system samples each of the N candidates using constrained sampling to ensure that each candidate satisfies the syntax, i.e., includes an exact quote from the context sequence identified by the natural language identifier in the sequence.

That is, as described above, the generator 306 samples a given candidate output sequence by, for each time step in the output sequence, generating a respective score for each token in the vocabulary conditioned on the first input text sequence and any tokens in the output sequence at any time steps before the time step in the first output sequence and, at each time step, selecting the token at the time step using the respective scores for the tokens in the vocabulary generated by the neural network for the time step.

When employing constrained sampling, the system constrains the sampling to only sample tokens that would be valid next tokens according to the output sequence.

For example, when generating the second output text sub-sequence and at each time step in the second output text sub-sequence that is after the first time step in the second output text sub-sequence, the generator 306 can receive the respective scores generated by the neural network at the time step and generate a constrained score distribution that assigns a non-zero score only to tokens that immediately follow the tokens already generated within the second output text sub-sequence in one (or more) of the natural language identifiers and then sample the token at the time step from the constrained score distribution instead of from the received score distribution. That is, the system constrains the sampling to assign a non-zero score only to tokens that would yield a valid prefix of one or more of the natural language identifiers in the corresponding input sequence if appended to the tokens already selected for the second output text sub-sequence.

As another example, in some cases the second output text sub-sequence is preceded by one or more first predetermined syntax tokens in the first output text sequence. For example, in the example of FIG. 3, the second output text sub-sequence is preceded by the tokens “>% (” in the output syntax.

In these cases, generating an output sequence using constrained sampling includes at a particular time step, determining that the one or more first predetermined syntax tokens have been selected at one or more time steps immediately preceding the particular time step and, in response, determining that the particular time step is the first time step in the second output text-subsequence. For example, the system can determine that the tokens “>% (” have already been sampled and, in response, determine that the next time step is the first time step in the second sub-sequence.

In this example, the system can receive the respective scores generated by the neural network at the particular time step and, in response to determining that the particular time step is the first time step in the second output text-subsequence, generate a constrained score distribution that assigns a non-zero score only to tokens that are the first token in one of the natural language identifiers in the corresponding input sequence and sample the token at the time step from the constrained score distribution. That is, the system constrains the sampling to assign a non-zero score only to tokens that are the first token of one or more of the natural language identifiers in the corresponding input sequence.

As another example, when using constrained sampling, at each time step in the third output text sub-sequence that is after the first time step in the third output text sub-sequence, the system can receive the respective scores generated by the neural network at the time step and generate a constrained score distribution that assigns a non-zero score only to tokens that immediately follow the tokens already generated within the third output text sub-sequence in the first context text sequence identified by the natural language identifier in the second output text sub-sequence. The system then samples the token at the time step from the constrained score distribution. That is, the system constrains the sampling to assign a non-zero score only to tokens that, if appended to the tokens already selected for the third output text sub-sequence, would yield a direct match to a sub-sequence in the first context text sequence identified by the natural language identifier in the second output text sub-sequence. Thus, the system ensures that the third output text sub-sequence is a direct quote from the context document identified by the natural language identifier in the second output text sub-sequence

As yet another example, in some cases, the third output text sub-sequence is preceded by one or more second predetermined syntax tokens in the first output text sequence. For example, in the example of FIG. 3, the second output text sub-sequence is preceded by the tokens “) % [” in the output syntax.

In these cases, when using constrained sampling, at a second particular time step, the system determines that the one or more second predetermined syntax tokens have been selected at one or more time steps immediately preceding the second particular time step and, in response, determines that the particular time step is the first time step in the third output text-subsequence. Then, upon receiving the respective scores generated by the neural network at the particular time step, the system generates a constrained score distribution that assigns a non-zero score only to tokens that appear in the first context text sequence identified by the natural language identifier in the second output text sub-sequence and samples the token at the time step from the constrained score distribution.

The system 100 then provides at least some of the text from the best sample 312 for presentation to the user. For example, the system 100 can render 314 in a user interface a presentation of the best sample 312.

As shown in FIG. 3, the presentation can include the text of the “claim”, i.e., of the first sub-sequence, the quote from the context document that supports the “claim,” i.e., the text of the third-subsequence, and, optionally, the document identifier from the second sub-sequence.

FIG. 4 shows an example of a user interface 400 that presents an output sequence to a user.

In the example of FIG. 4, the user has submitted a query 402 “What kind of animal is Scooby Doo?”

In response, the system 100 has generated an output sequence that includes three sub-sequences: (i) “A Great Dane dog,” (ii) “Wikipedia Page: Scooby Doo” and (iii) a quote from the Wikipedia page that has the title “Scooby Doo.”

Then, in response to the user query 402, the system presents, in the user interface 400, the first sub-sequence 404, the second sub-sequence 406, and the third sub-sequence 408.

Additionally, the system has displayed the first sub-sequence 404 as a hyperlink that links to the source of the third sub-sequence 408, i.e., that links to the Wikipedia page of Scooby Doo, i.e., to the web page titled “Wikipedia Page: Scooby Doo.” Including the hyperlink in the user interface 400 allows the user to navigate to the source indicated by the second sub-sequence to, e.g., verify the accuracy of the quote or to obtain additional context about the response.

FIG. 5 shows an example of training the language model neural network 114.

As shown in FIG. 5, the system obtains 502 a pre-trained language model.

For example, the language model may have been trained on a language modeling objective on a large corpus of text documents, as described above.

After obtaining 502 the pre-trained language model, the system generates samples 504 and rates the generated samples via human evaluation.

For example, to obtain each rating, the system can present a question and two candidate answers, e.g., two samples generated using the pre-trained language model with few shot prompting, to a rater user. Each candidate answer can be split into a “claim” section and a “supporting evidence” section, e.g., as shown above with reference to FIG. 4.

The system can then obtain an input from the rater user specifying whether either claim is a plausible response to the question, whether the claim is supported by the accompanying quote evidence, and which answer is preferred by the rater user. A plausible response to the question is one that is a reasonable on-topic response to the question. A supported response is one for which the provided evidence is sufficient to verify the validity of the response.

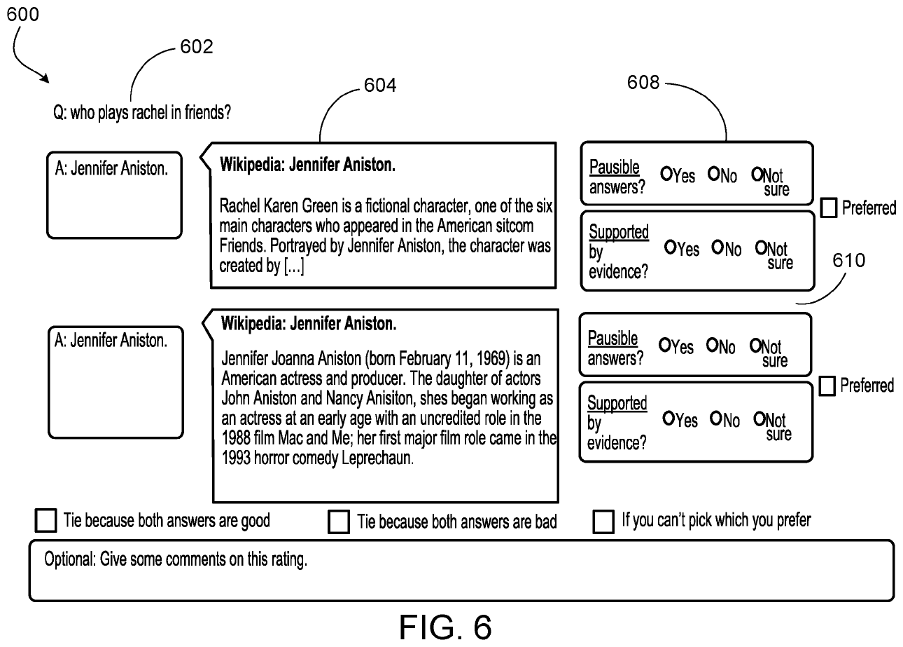

One example of a user interface that can be used to obtain inputs from users is shown in FIG. 6.

That is, FIG. 6 shows an example user interface 600 for rating a generated sample, e.g., that can receive inputs for human evaluations of generated samples.

As shown in FIG. 6, the user is presented with a query 602 and two candidate responses 604 and 606 to the query 602. Each candidate response 604 and 606 includes a response to the query, supporting evidence from the response, and an identifier for the source of the supporting evidence.

For each candidate responses 604 and 606, the user interface presents a corresponding selection element 608 and 610 that allows the user to submit an input indicating whether the corresponding candidate response is a plausible answer (or to indicate that the user is not sure) and to submit an input indicating whether the corresponding candidate response is supported by the corresponding supporting evidence (or to indicate that the user is not sure).

The selection elements 608 and 610 also each allow the user to submit an input indicating that the corresponding candidate response 604 or 606 is the preferred response (out of the two candidate responses) to the query 602.

The user interface 600 can also allow the user to submit an input indicating that the two responses are “tied” or to submit comments on the sample.

Returning to the description of FIG. 5, the system then uses the rated samples to perform supervised fine-tuning (SFT) 506, in which the system trains the language model on the rated samples through supervised learning.

That is, for each sample used for SFT, the system trains the language model to produce the claim and the supporting evidence in the sample, given the question in the sample and a set of context sequences that includes a context sequence that has the text of the supporting evidence.

Optionally, when performing SFT, the system can use only the samples that were rated as both plausible and supported for the supervised fine-tuning.

As a particular example, the system can generate the input sequence for a given sample during SFT as follows.

For a certain proportion of the samples, e.g., for ⅓ or ½ of the data, the system uses just a single document in the context, the same document from which the supporting evidence was extracted, enforcing that the supporting evidence is present inside the context sequence.

For the remainder of the samplers, the system uses n documents in the context, e.g., where n is drawn at random between 1 and a fixed number, e.g., 5, 10 or 15. Similarly, the system enforces that the target document and the supporting evidence quote are present in the context sequence. For the rest of the documents in the context sequence, the system can use, e.g., the n−1 top search results for the question as provided by the search engine.

The system can truncate each of the context documents so that the total token length of the input sequence does not exceed a fixed number that is based on the context window of the language model. This token length allowance can be split at random between the documents included in the prompt, so that the language model sees different sized context sequences from different context documents within the same input sequence. When truncating a given context document to its maximum allowed length, the system can ensure that each document contains a snippet, as described above.

Optionally, after performing supervised fine-tuning (SFT) 506, the system can use the SFT model to generate additional samples that are again rated via human evaluation.

The system then trains a reward model (RM) 508 on the generated samples, e.g., the originally generated samples or the originally generated samples and the additional samples generated using the SFT model.

As described above, the learned reward model is a model, e.g., another language model neural network, that receives as input an input text query and a response and a quote generated by the neural network 114 and generates as output a score that represents the quality of the response and quote.

For example, the system can train the reward model as a classifier that predicts a binary variable indicating which example in a given pair was preferred, given a query and a response string. That is, the system can compute a probability that the first example in the pair was preferred given the scores generated by the reward model for both examples in the pair. For example, the system can train the reward model using a cross-entropy objective using the user preferences as the ground truth and the computed probability as the prediction.

Optionally, during the training, the reward model also predicts the binary Supported and Plausible judgements of the responses in the pair as an auxiliary loss. Thus, in these cases, the final loss is a combination of, e.g., the average of or a weighted average of, the pairwise preference prediction loss and the auxiliary prediction loss.

In some implementations, the system can augment the RM training set with a set of of fabricated (“synthetic”) comparisons. For example, the system can generate fabricated comparisons from the supported and refuted claims of a fact checking dataset. One example of such a data set is the FEVER data set (Thorne et al., 2018). Including these fabricated comparisons can provide an additional out-of-distribution mode of question answering that is non-extractive, and can make the reward model better at verifying supportiveness of the evidence. An example of such a data set, e.g., the FEVER dataset, can contain claims generated by altering sentences extracted from sour text. These claims are then classified as Supported, Refuted or NotEnough and marked with associated evidence. To transform such claims into examples of questions with comparison of answers, the system can use any of a variety of techniques. Some examples of types of techniques will now be described.

Type A: The system can generate questions by a direct templating operations from claims (e.g. ‘{claim}?’, ‘Is it true that {claim}?’, ‘Is it correct to say that {claim}?’, ‘{claim}. Do you agree?’). The examples compare affirmative answer like ‘Yes’, ‘This is correct’, ‘It is true’ combined with supporting quote and negative answer combined with the same quote. If the original claim was supported then the affirmative answer is marked as preferred, supported and plausible. Otherwise the negative one is marked as preferred supported and plausible.

Type B: The system can transform claims into questions using a few-shot prompted, pre-trained language model neural network. For example a claim Roman Atwood is a content creator. could be transformed into Who is Roman Atwood?. As a comparison for a claim that has been transformed into a question, the system can use one answer as the corresponding claim from the data set (with supporting quote) and a direct negation of the claim produced via templating (e.g. ‘It is not true that {claim}’) as the other answer. If the original claim was supported then the answer containing the claim is marked as preferred, supported and plausible. Otherwise the negated claim is marked as preferred. As another example, if the original claim was supported, the system can use the original claim as one answer and a randomly generated claim as the comparison, with the original claim being marked preferred, supported and plausible.

As described above, the system can then use the reward model at sampling time to assign scores to candidate output sequences.

After training the RM 508, the system can use the trained reward model to further fine-tune the SFT model through reinforcement learning 510. That is, the system uses the reward model to perform a reinforcement learning from human preferences (RLfHP) technique by training the model to maximize expected rewards as predicted by the trained RM 508.

Optionally, the system can then use the further fine-tuned model to generate additional samples for human evaluation and to re-fine tune the model through SFT or RL or both, to re-train the RM, or both. That is, the system can perform more than one iteration of the described training loop to further fine-tune the language model, to further fine-tune the reward model, or both.

Additionally, while the example of FIG. 5 describes that the system fine-tunes the language model using both SFT and RL, in some cases, the system uses only SFT or RL instead of using both. For example, when using the reward model for re-ranking, it may increase performance to use a model that is only fine-tuned through SFT or RL (instead of both) so that the reward model is provided for more diverse samples to re-rank.

A description of self-attention, as may be employed by the language model neural network, now follows.

A self-attention block, as referred to above, is a neural network layer that includes an attention mechanism that operates over the self-attention block input (or an input derived from the layer input) to generate the self-attention block output. A self-attention mechanism may be causally masked so that any given position in an input sequence does not attend over (e.g. use data from) any positions after the given position in the input sequence. There are many different possible attention mechanisms. Some examples of self-attention layers including attention mechanisms, are described in Vaswani et al. “Attention is all you need”, 31st Conference on Neural Information Processing Systems (NIPS 2017), Long Beach, CA, USA; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, an attention mechanism maps a query and a set of key-value pairs to an output, where the query, keys, and values are all vectors. The output is computed as a weighted sum of the values, where the weight assigned to each value is computed by a compatibility function, e.g. a dot product or scaled dot product, of the query with the corresponding key.

Generally, a self-attention mechanism is configured to relate different positions in the same sequence to determine a transformed version of the sequence as an output. For example the attention layer input may comprise a vector for each element of the input sequence. These vectors provide an input to the self-attention mechanism and are used by the self-attention mechanism to determine a new representation of the same sequence for the attention layer output, which similarly comprises a vector for each element of the input sequence. An output of the self-attention mechanism may be used as the attention layer output, or it may be processed by one or more of feed-forward layers, skip connections, or normalization operations to provide the attention layer output.

In some implementations the attention mechanism is configured to apply each of a query transformation e.g. defined by a matrix W^{Q}, a key transformation e.g. defined by a matrix W^{K}, and a value transformation e.g. defined by a matrix W^{V}, to the attention layer input which is the input data X to the attention layer, to derive a query matrix Q=XW^{Q} that includes a respective query for each vector in the input sequence, key matrix K=XW^{K} that includes a respective key for each vector in the input sequence, and value matrix V=XW^{V} that includes a respective value for each vector in the input sequence, which are used determine an attended sequence for the output. For example the attention mechanism may be a dot product attention mechanism applied by applying each query vector to each key vector to determine respective weights for each value vector, then combining the value vectors using the respective weights to determine the self-attention layer output for each element of the input sequence. The self-attention layer output may be scaled by a scaling factor e.g. by the square root of the dimensions of the queries and keys, to implement scaled dot product attention. Thus, for example, an output of the attention mechanism may be determined as

$$softmax ( \frac{Q {K}^{T}}{\sqrt{d}} ) V$$

where d is a dimension of the key (and value) vector. In another implementation the attention mechanism be comprise an “additive attention” mechanism that computes the compatibility function using a feed-forward network with a hidden layer. The output of the attention mechanism may be further processed by one or more fully-connected, feed forward neural network layers.

The attention mechanism may implement multi-head attention, that is, it may apply multiple different attention mechanisms in parallel. The outputs of these may then be combined, e.g. concatenated, with a learned linear transformation applied to reduce to the original dimensionality if necessary.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving an input text query;
obtaining one or more first context text sequences and a respective natural language identifier for each of the first context text sequences;
generating a first input sequence that includes the input text query, the one or more first context text sequences, and the respective natural language identifiers for each of the one or more first context text sequences;
processing the first input text sequence using an auto-regressive language model neural network to generate a first output text sequence that comprises:
(i) a first output text sub-sequence that is a response to the input text query;
(ii) a second output text sub-sequence that is one of the respective natural language identifiers for the first context text sequences, and
(iii) a third output text sub-sequence that is text from the first context text sequence identified by the natural language identifier in the second output text sub-sequence; and
providing at least the first output text sub-sequence and the third output text sub-sequence in response to the input text query.

2. The method of claim 1, wherein providing at least the first output text sub-sequence and the first context text sequence in response to the input text query comprises
providing the first output text sub-sequence, the second output text sub-sequence, and the third output text sub-sequence in response to the query.

3. The method of claim 1, further comprising:
determining, from the second output text sub-sequence, a source of the first context text sequence identified by the natural language identifier in the second output text sub-sequence; and
providing a reference to the source of the first context text sequence in response to the query.

4. The method of claim 1, further comprising:
obtaining one or more second context text sequences and a respective natural language identifier for each of the second context text sequences;
generating a second input sequence that includes the input text query, the one or more second context text sequences, and the respective natural language identifiers for each of the one or more second context text sequences;
processing the second input text sequence using the auto-regressive language model neural network to generate a second output text sequence that comprises:
(i) a fourth output text sub-sequence that is a response to the input text query;
(ii) a fifth output text sub-sequence that is one of the respective natural language identifiers for the second context text sequences, and
(iii) a sixth output text sub-sequence that is text from the second context text sequence identified by the natural language identifier in the fifth output text sub-sequence;
generating a respective score for each output text sequence in a set that includes the first and second output text sequences;
determining that the first output text sequence has a highest score of any output text sequence in the set; and
providing at least the first output text sub-sequence and the third output text sub-sequence in response to the input text query in response to determining that the first output text sequence has the highest score.

5. The method of claim 4, wherein generating a respective score for each output text sequence in a set that includes the first and second output text sequences comprises:
scoring each of the output text sequences using a learned reward model.

6. The method of claim 1, wherein the first output sequence includes a respective token from a vocabulary of tokens at each of a plurality of time steps, wherein the auto-regressive neural network is configured to, for each time step in the first output sequence, generate a respective score for each token in the vocabulary conditioned on the first input text sequence and any tokens in the output sequence at any time steps before the time step in the first output sequence, and wherein generating the first output sequence comprises:
at each time step, selecting the token at the time step using the respective scores for the tokens in the vocabulary generated by the neural network for the time step.

7. The method of claim 6, wherein generating the first output sequence comprises:
at each time step in the second output text sub-sequence that is after the first time step in the second output text sub-sequence:
receiving the respective scores generated by the neural network at the time step;
generating a constrained score distribution that assigns a non-zero score only to tokens that immediately follow the tokens already generated within the second output text sub-sequence in one of the natural language identifiers; and
sampling the token at the time step from the constrained score distribution.

8. The method of claim 7, wherein the second output text sub-sequence is preceded by one or more first predetermined syntax tokens in the first output text sequence, and wherein generating the first output sequence comprises:
at a particular time step, determining that the one or more first predetermined syntax tokens have been selected at one or more time steps immediately preceding the particular time step and, in response, determining that the particular time step is the first time step in the second output text-subsequence;
receiving the respective scores generated by the neural network at the particular time step;
in response to determining that the particular time step is the first time step in the second output text-subsequence, generating a constrained score distribution that assigns a non-zero score only to tokens that are the first token in one of the natural language identifiers; and
sampling the token at the time step from the constrained score distribution.

9. The method of claim 1, wherein generating the first output sequence comprises:
at each time step in the third output text sub-sequence that is after the first time step in the third output text sub-sequence:
receiving the respective scores generated by the neural network at the time step;
generating a constrained score distribution that assigns a non-zero score only to tokens that immediately follow the tokens already generated within the third output text sub-sequence in the first context text sequence identified by the natural language identifier in the second output text sub-sequence; and
sampling the token at the time step from the constrained score distribution.

10. The method of claim 9, wherein the third output text sub-sequence is preceded by one or more second predetermined syntax tokens in the first output text sequence, and wherein generating the first output sequence comprises:
at a second particular time step, determining that the one or more second predetermined syntax tokens have been selected at one or more time steps immediately preceding the second particular time step and, in response, determining that the particular time step is the first time step in the third output text-subsequence;
receiving the respective scores generated by the neural network at the particular time step;
in response to determining that the particular time step is the first time step in the third output text-subsequence, generating a constrained score distribution that assigns a non-zero score only to tokens that appear in the first context text sequence identified by the natural language identifier in the second output text sub-sequence; and
sampling the token at the time step from the constrained score distribution.

11. The method of claim 1, wherein obtaining one or more first context text sequences and a respective natural language identifier for each of the first context text sequences comprises:
submitting a query derived from the input text query to a search engine;
obtaining, from the search engine, one or more context documents in response to the query; and
selecting the one or more first context sequences from the one or more context documents.

12. The method of claim 11, wherein the respective natural language identifier for each of the first context text sequences is a title of the context document from which the first context text sequence is selected.

13. The method of claim 1, wherein the neural network has been pre-trained through unsupervised learning on a language modeling objective.

14. The method of claim 1, wherein the neural network has been fine-tuned through supervised learning, reinforcement learning, or both.

15. A system comprising:
one or more computers; and
one or more storage devices storing instructions that, when executed by the one or more computers, cause the one or more computers to perform operations comprising:
receiving an input text query;
obtaining one or more first context text sequences and a respective natural language identifier for each of the first context text sequences;
generating a first input sequence that includes the input text query, the one or more first context text sequences, and the respective natural language identifiers for each of the one or more first context text sequences;
processing the first input text sequence using an auto-regressive language model neural network to generate a first output text sequence that comprises:
(i) a first output text sub-sequence that is a response to the input text query;
(ii) a second output text sub-sequence that is one of the respective natural language identifiers for the first context text sequences, and
(iii) a third output text sub-sequence that is text from the first context text sequence identified by the natural language identifier in the second output text sub-sequence; and
providing at least the first output text sub-sequence and the third output text sub-sequence in response to the input text query.

16. One or more non-transitory computer-readable storage media storing instructions that when executed by one or more computers cause the one or more computers to perform operations comprising:
receiving an input text query;
obtaining one or more first context text sequences and a respective natural language identifier for each of the first context text sequences;
generating a first input sequence that includes the input text query, the one or more first context text sequences, and the respective natural language identifiers for each of the one or more first context text sequences;
processing the first input text sequence using an auto-regressive language model neural network to generate a first output text sequence that comprises:
(i) a first output text sub-sequence that is a response to the input text query;
(ii) a second output text sub-sequence that is one of the respective natural language identifiers for the first context text sequences, and
(iii) a third output text sub-sequence that is text from the first context text sequence identified by the natural language identifier in the second output text sub-sequence; and
providing at least the first output text sub-sequence and the third output text sub-sequence in response to the input text query.

17. The system of claim 15, wherein providing at least the first output text sub-sequence and the first context text sequence in response to the input text query comprises
providing the first output text sub-sequence, the second output text sub-sequence, and the third output text sub-sequence in response to the query.

18. The system of claim 15, the operations further comprising:
determining, from the second output text sub-sequence, a source of the first context text sequence identified by the natural language identifier in the second output text sub-sequence; and
providing a reference to the source of the first context text sequence in response to the query.

19. The system of claim 15, the operations further comprising:
obtaining one or more second context text sequences and a respective natural language identifier for each of the second context text sequences;
generating a second input sequence that includes the input text query, the one or more second context text sequences, and the respective natural language identifiers for each of the one or more second context text sequences;
processing the second input text sequence using the auto-regressive language model neural network to generate a second output text sequence that comprises:
(i) a fourth output text sub-sequence that is a response to the input text query;
(ii) a fifth output text sub-sequence that is one of the respective natural language identifiers for the second context text sequences, and
(iii) a sixth output text sub-sequence that is text from the second context text sequence identified by the natural language identifier in the fifth output text sub-sequence;
generating a respective score for each output text sequence in a set that includes the first and second output text sequences;
determining that the first output text sequence has a highest score of any output text sequence in the set; and
providing at least the first output text sub-sequence and the third output text sub-sequence in response to the input text query in response to determining that the first output text sequence has the highest score.

20. The system of claim 19, wherein generating a respective score for each output text sequence in a set that includes the first and second output text sequences comprises:
scoring each of the output text sequences using a learned reward model.
